(19) United States
(12) Patent Application Publication
(10) Pub. No.: US 2026/0257948 A1
(43) Pub. Date: Sep. 3, 2026

(54) Resourceful Treatment Method of BOE Waste Liquid

(71) Applicants: DONGJIANG ENVIRONMENTAL COMPANY LIMITED, Shenzhen City, Guangdong Province (CN); JIANGXI DONGJIANG ENVIRONMENTAL PROTECTION TECHNOLOGY CO., LTD., Yichun, Jiangxi Province (CN)

(72) Inventors: Wenbiao Wu, Shenzhen City, Guangdong Province (CN); Lin Zhou, Yichun, Jiangxi Province (CN); Hao Chen, Shenzhen City, Guangdong Province (CN); Weining Qin, Shenzhen City, Guangdong Province (CN); Chaofeng Zhou, Shenzhen City, Guangdong Province (CN); Weihan Zhou, Shenzhen City, Guangdong Province (CN); Yuqiang Zhou, Shenzhen City, Guangdong Province (CN)

(21) Appl. No.: 18/880,101

(22) PCT Filed: Mar. 3, 2023
(86) PCT No.: PCT/CN2023/079428

§ 371 Date: Dec. 30, 2024

(51) Int. Cl. C02F 1/52; C02F 1/00; C02F 1/04; C02F 1/28; C02F 101/14; C02F 103/34

(52) U.S. Cl. CPC C02F 1/5245; C02F 1/001; C02F 1/048; C02F 1/281; C02F 2001/5218; C02F 2101/14; C02F 2103/346; C02F 2209/06

(57) ABSTRACT

The present invention relates to the technical field of water treatment, and more specifically relates to a recycling treatment method for a BOE waste liquid. The key point of the technical solution of the method comprises the following steps: S1, adding a sodium salt solution to a BOE waste liquid for reaction to obtain sodium fluosilicate and a first waste liquid; S2, adding an aluminum salt solution to the first waste liquid, and adjusting the pH to 4-7 to obtain cryolite and a second waste liquid; S3, adding a fluorine removal agent and a recapturing agent to the second waste liquid to obtain a first waste residue and a third waste liquid; S4, adjusting the pH of the third waste liquid to 2-4, and subjecting the third waste liquid to evaporative crystallization to obtain evaporated condensate water and a concentrated solution; S5, pumping the concentrated solution into a cooling crystallization tank for cooling, subjecting same to centrifugal separation to obtain an ammonium salt and a final mother solution; and S6, returning the third waste liquid and the final mother solution to S1 and S2 for circulation. The present invention can achieve resource recovery of components in the BOE waste liquid, and has the advantage of obtaining high-value sodium fluosilicate, cryolite and agricultural ammonium salt products.

### TECHNICAL FIELD

The present invention relates to the technical field of water treatment and, in more particular, to a resourceful treatment method of BOE waste liquid.

### BACKGROUND

The direct reaction of hydrofluoric acid and silicon dioxide is relatively violent, and it easily causes defective products in the pattern etching of silicon wafers (chips) in the semiconductor industry. BOE (buffered oxide etch) is a mixture of HF and NH₄F. It is usually obtained by adding 40 wt % NH₄F solution to 49 wt % hydrofluoric acid and reacting same at room temperature. The concentration of BOE can be adjusted according to the required etching rate. The NH₄F in the BOE acts as a buffer. In the process of silicon dioxide reacting with HF in the BOE to generate H₂SiF₆, NH₄F continuously ionizes to supplement the fluoride ions required for the reaction, thereby obtaining a stable etching rate and achieving stability in pattern etching.

The etching principle of BOE is as follows:

$${SiO}_{2} + 4 {NH}_{4} {HF}_{2} = {( {NH}_{4} )}_{2} {SiF}_{6} + 2 {NH}_{4} F + 2 {H}_{2} O$$

When the etching effect of the BOE deteriorates, it is discharged as waste liquid. The main component of the BOE waste liquid is a mixture of 3-10 wt % of ammonium fluosilicate, 10-20 wt % of ammonium fluoride and a small amount (about 0.5 wt %) of unreacted hydrofluoric acid, and the BOE waste liquid also comprises a small amount of other components, such as 300-50000 mg/L sulfates, 500-20000 mg/L chloride ion, 50-100 mg/L heavy metals (in terms of Pb).

Invention patent CN114132953A discloses a system and preparation method for preparing high-purity calcium fluoride using BOE waste liquid. That is, a calcium salt reacts with fluorides and fluosilicates in BOE waste liquid, and then a calcium fluoride product with a purity of 97% or higher is obtained by high-temperature firing. Although this method can realize the resource utilization of the main components in BOE waste liquid, it requires a high-temperature firing process and has the disadvantages of high energy consumption and low product value.

Invention patent CN 112158858A discloses a method for preparing ammonium bifluoride by using BOE waste liquid. That is, firstly, barium hydroxide is used to remove fluosilicates and sulfates out of the waste liquid, and then anhydrous hydrogen fluoride is added to convert the ammonium fluoride in the waste liquid into ammonium bifluoride, and the ammonium bifluoride is evaporated and crystallized by a three-effect evaporator at a temperature of 70° C. to 120° C. and a pressure of −0.03to −0.06 Mpa to obtain an ammonium bifluoride product. This method seriously corrodes the three-effect evaporator, which is not conducive to the long-term use of the equipment.

Invention patent CN 114105097A discloses a method and device for preparing hydrogen fluoride by electrodialysis of BOE waste liquid. That is, firstly, BOE waste liquid reacts with ammonia to generate an ammonium fluoride solution; the ammonium fluoride solution is then decomposed by bipolar membrane electrodialysis to obtain a dilute hydrofluoric acid solution and dilute ammonia water; the dilute ammonia water is stripped to evaporate ammonia gas out, and some of ammonia gas is returned to the front end to react with BOE waste liquid; the dilute hydrofluoric acid solution is concentrated by distillation and then mixed with concentrated sulfuric acid and hydrogen fluoride gas is then evaporated out of the mixed solution. This method does not consider the problem of fluorosilicic acid in the BOE waste liquid. The membrane may be blocked during the bipolar membrane electrodialysis process. The problem of strong corrosion to the evaporator equipment is also caused during the evaporation and concentration process of dilute hydrofluoric acid solution.

The harmless treatment method for BOE waste liquid is generally to neutralize BOE waste liquid with lime or slaked lime to generate calcium fluoride and ammonia water. The treatment units with good conditions will recycle the ammonia water and landfill the calcium fluoride. This treatment method not only wastes a lot of precious resources, but also has problems such as low calcium fluoride filtration speed, incomplete fluoride ion removal (fluorine residual content is as high as 50-500 mg/L), serious unorganized ammonia emission during the treatment process, and high sludge landfill disposal cost.

### SUMMARY

In view of the shortcomings of the prior art, an objective of the present invention is to provide a resourceful treatment method of BOE waste liquid. The method can realize the resource recovery of the main components of the waste liquid, such as fluosilicates, fluorides, ammonia nitrogen, sulfates or chlorides, and also has good treatment effect without unorganized emission of ammonia during the treatment process. Moreover, fluoride ions are completely removed (the residual fluoride can be stably reduced to 3 mg/L or below), thereby significantly reducing the corrosion of fluoride ions to an evaporator.

The above technical objectives of the present invention are achieved through the following technical solutions: A resourceful treatment method of BOE waste liquid, including the following steps:
S1, dissolving a sodium salt to obtain a sodium salt solution, adding the sodium salt solution to a BOE waste liquid for reaction for 30 min, and then filtering the reaction solution to obtain sodium fluosilicate and a first waste liquid;
S2, dissolving an aluminum salt to obtain an aluminum salt solution, adding the aluminum salt solution to the first waste liquid, adjusting the pH of the first waste liquid to 4-7 by using a first pH adjuster, reacting same for 1-2 h and then filtering the reaction solution to obtain cryolite and a second waste liquid;
S3, adding a fluorine removal agent and a heavy metal capturing agent to the second waste liquid for reaction for 30 min, and then filtering the reaction solution to obtain a first waste residue and a third waste liquid, and landfilling the first waste residue;
S4, adding a second pH adjuster to the third waste liquid to adjust the pH of the third waste liquid to 2-4, subjecting the third waste liquid to evaporative crystallization to obtain evaporated condensate water and a concentrated solution, subjecting the evaporated condensate water to a biochemical treatment, and discharging the evaporated condensate water after same reaches the discharge standard;
S5, pumping the concentrated solution into a cooling crystallization tank for cooling for 40° C., and subjecting same to centrifugal separation to obtain an ammonium salt and a final mother solution; and
S6, returning the third waste liquid and the final mother solution to S1 and S2 for circulation so as to prepare the sodium salt solution and the aluminum salt solution.

In an embodiment, the sodium salt includes one or more of sodium chloride, sodium sulfate, sodium carbonate and sodium bicarbonate, and the amount of the sodium salt added (in terms of sodium) is calculated based on the sodium required to completely remove fluosilicates and fluorides out of the BOE waste liquid and precipitate sodium fluosilicate and sodium hexafluoroaluminate, and an excess coefficient is 1-1.2 times.

In an embodiment, the aluminum salt includes one or more of aluminum chloride, aluminum sulfate and sodium aluminate, and the amount of the aluminum salt added (in terms of aluminum) is calculated based on the aluminum required to completely remove fluorides out of the first waste liquid and precipitate sodium hexafluoroaluminate, and an excess coefficient is 1-1.2 times.

In one embodiment, the first pH adjuster includes one or more of sodium hydroxide, sodium carbonate, sodium bicarbonate, ammonia water, ammonium bicarbonate and ammonium carbonate.

In an embodiment, step S1 and step S2 also include washing and drying the sodium fluosilicate and the cryolite, respectively.

In an embodiment, the fluorine removal agent includes one or more of aluminum chloride, polyaluminum chloride, aluminum sulfate, hydroxyapatite, magnesium chloride and magnesium sulfate.

In an embodiment, the second pH adjuster is hydrochloric acid or sulfuric acid.

The resourceful treatment method of BOE waste liquid described above has the following beneficial effects:
1. The present invention can fully realize the resource recovery of the main components in the BOE waste liquid, produce sodium fluosilicate, cryolite and agricultural ammonium salt products with purity reaching the relevant national standards, thereby realizing the high-value utilization of resources.
2. In the present invention, by adding an excess of sodium salt in step S1, the fluosilicate in the waste liquid can be precipitated more completely, so that the yield of sodium fluosilicate is increased, and the excess sodium ions can continue to be used in the preparation of cryolite products in S2.
3. In the present invention, by controlling the crystallization process in step S1 and step S2, the moisture content of the two products can be significantly reduced, the filtration efficiency can be improved, and the subsequent drying costs of the products can be reduced.
4. In the present invention, the fluorine removal agent removes the fluoride ions out of the wastewater in the form of a complex salt precipitate with lower solubility, thereby stably reducing the fluoride content to 3 mg/L or below and ameliorating the corrosion of fluoride ions to the subsequently used evaporator. Moreover, the fluorine removal agent can simultaneously remove the heavy metal ions out of the waste liquid, thereby preventing the heavy metal ions from entering the subsequent ammonium salt product and affecting the quality of the ammonium salt product.
5. In the present invention, all reactions are carried out at the pH of 7 or less, and there is basically no unorganized emission of ammonia during the treatment process, thereby being friendly to the environment and the physical and mental health of operators.

### BRIEF DESCRIPTION OF THE DRAWINGS

FIG. 1 is a flow chart of the steps of the present invention; and

FIG. 2 is a schematic diagram of the process of the present invention.

### DETAILED DESCRIPTION OF THE EMBODIMENTS

The present invention is further described in detail below in conjunction with examples. It should be noted that the following examples are intended to facilitate the understanding of the present invention instead of limiting the present invention in any way. Unless otherwise specified, all technical and scientific terms used herein have the same meanings as those generally understood by a person of ordinary skill in the art to which the invention belongs. In the event of a conflict, the definitions in this specification shall prevail.

As used herein, the term “made of” is synonymous with “comprising”. As used herein, the terms “comprising”, “including”, “having”, “containing” or any other variation thereof, are intended to cover a non-exclusive inclusion. For example, a composition, step, method, article, or apparatus comprising the listed elements is not necessarily limited to only those elements but may include other elements not expressly listed or inherent to such composition, step, method, article, or apparatus.

The conjunction “consisting of” excludes any unspecified element, step, or component. If used in a claim, this phrase renders the claim closed so that it does not include materials other than those described, except for conventional impurities associated therewith. When the phrase “consisting of” appears in a clause of the body of the claim rather than immediately following the subject matter, it is limited only to the elements described in that clause; other elements are not excluded from the claim as a whole.

When an amount, concentration, or other value or parameter is expressed as a range, a preferred range, or a range defined by a series of upper preferred values and lower preferred values, it should be understood as specifically disclosing all ranges formed by any pairing of any upper range limit or preferred value with any lower range limit or preferred value, regardless of whether the range is disclosed alone. For example, when a range “1 to 5” is disclosed, the described range should be interpreted as including the ranges “1 to 4”, “1 to 3”, “1 to 2”, “1 to 2 and 4 to 5”, and “1 to 3 and 5”. When a numerical range is described herein, unless otherwise stated, the range is intended to include its end values and all integers and fractions within the range.

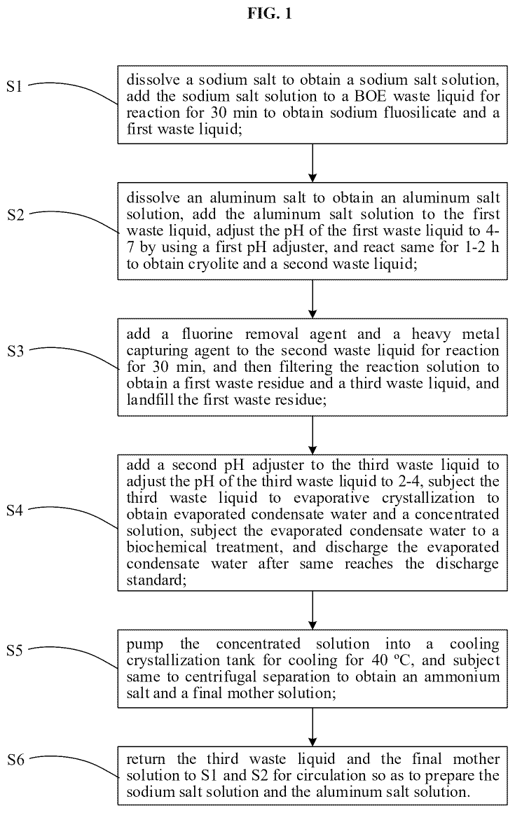

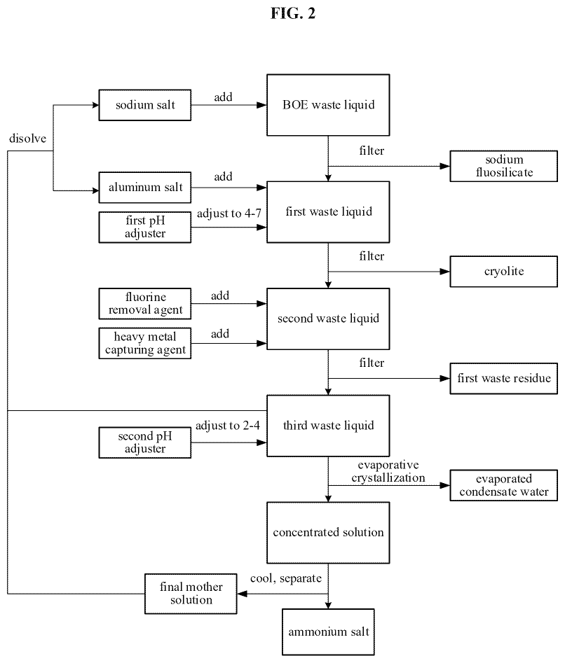

Referring to FIG. 1 and FIG. 2, a resourceful treatment method of BOE waste liquid includes the following steps:

S1, dissolving a sodium salt to obtain a sodium salt solution, adding the sodium salt solution to a BOE waste liquid for reaction for 30 min, and then filtering the reaction solution to obtain sodium fluosilicate and a first waste liquid.

The sodium salt solution is used to react with fluosilicates in the BOE waste liquid to obtain sodium fluosilicate, and to prepare cryolite in the subsequent steps. The sodium salt solution required to completely precipitate fluosilicates and fluorides to obtain sodium fluosilicate and sodium hexafluoroaluminate is added to the BOE waste liquid. The specific calculation process of the required amount of sodium salt solution is as follows: firstly, determining the fluosilicate content in the BOE waste liquid, calculating the amount of fluosilicate substance (n_{fluosilicate}), and calculating the mass m₁ of the required sodium salt solution according to the ratio: n_{sodium}:n_{fluosilicate}=2-2.4:1; then, determining the fluoride content in the waste liquid after complete removal of fluosilicates, calculating the amount of fluoride substance (n_{fluoride}), and calculating the mass m₂ of the required sodium salt solution according to the ratio: n_{sodium}:n_{fluoride}=0.5-0.6:1; at last, adding m₁ to m₂ to obtain the total mass of the sodium salt solution required to be added in this step.

S2, dissolving an aluminum salt to obtain an aluminum salt solution, adding the aluminum salt solution to the first waste liquid, adjusting the pH of the first waste liquid to 4-7 by using a first pH adjuster, reacting same for 1-2 h and then filtering the reaction solution to obtain cryolite and a second waste liquid.

In actual operation, the aluminum salt solution required for completely precipitating sodium hexafluoroaluminate is added to the first waste liquid. The specific calculation process of the required amount of aluminum salt solution is as follows: determining the fluoride content in the first waste liquid, calculating the amount of fluoride substance (n_{fluoride}), and then calculating the mass of the required aluminum salt solution according to the ratio: nₐₗᵤₘᵢₙᵤₘ:n_{fluoride}=1.0-1.2:6, thus obtaining the mass of the aluminum salt solution required to be added in this step.

S3, adding a fluorine removal agent and a heavy metal capturing agent to the second waste liquid for reaction for 30 min, and then filtering the reaction solution to obtain a first waste residue and a third waste liquid, and landfilling the first waste residue.

The amount of the fluorine removal agent and the heavy metal capturing agent added to the second waste liquid can be calculated as follows, and the specific amount can be adjusted according to the removal effect: determining the mass concentrations (mg/L) of the remaining fluoride ions and heavy metals (in terms of Pb) in the second waste liquid, multiplying the mass concentrations by a treatment volume to obtain the masses of fluoride ions and heavy metals (in terms of Pb) (m_{fluoride ions} and m_{heavy metals}), and then respectively adding the fluorine removal agent and the heavy metal capturing agent in the following ratios: m_{fluorine removal agent}:m_{fluoride ions}=2-10:1, m_{heavy metal capturing agent}: m_{heavy metals}=10-20:1.

S4, adding a second pH adjuster to the third waste liquid to adjust the pH of the third waste liquid to 2-4, subjecting the third waste liquid to evaporative crystallization to obtain evaporated condensate water and a concentrated solution, subjecting the evaporated condensate water to a biochemical treatment, and discharging the evaporated condensate water after same reaches the discharge standard.

S5, pumping the concentrated solution into a cooling crystallization tank for cooling for 40° C., and subjecting same to centrifugal separation to obtain an ammonium salt and a final mother solution.

In the present invention, the obtained ammonium salt is ammonium chloride or ammonium sulfate, and the ammonium salt is packaged and sold or packaged and sold after being dried.

S6, returning the third waste liquid and the final mother solution to S1 and S2 for circulation so as to prepare the sodium salt solution and the aluminum salt solution.

After the final mother solution is circulated too many times, it needs to be open-circuited.

Specifically, the sodium salt includes one or more of sodium chloride (NaCl), sodium sulfate, sodium carbonate and sodium bicarbonate.

In actual operation, sodium chloride or sodium sulfate is mainly used, and sodium carbonate and sodium bicarbonate are used to control the pH of the reaction system within a limited range. The sodium salt is generally added in the form of a solution, and may also be added in the form of a solid.

Specifically, the aluminum salt includes one or more of aluminum chloride, aluminum sulfate and sodium aluminate.

In actual operation, aluminum chloride or aluminum sulfate is mainly used, and sodium aluminate is used to control the pH of the reaction system within a limited range; and in order to obtain a cryolite product with a low moisture content, the aluminum salt needs to be added in the form of a solution.

Specifically, the first pH adjuster includes one or more of sodium hydroxide, sodium carbonate, sodium bicarbonate, ammonia water, ammonium bicarbonate and ammonium carbonate; the pH of the first waste liquid is adjusted to 4-7, preferably 5.0-6.5 by the first pH adjuster.

Specifically, S1 and S2 also respectively include drying or washing and drying the sodium fluosilicate and the cryolite; the dried sodium fluosilicate and cryolite are ready for packaging and sales.

Specifically, the fluorine removal agent includes one or more of aluminum chloride, polyaluminum chloride, aluminum sulfate, hydroxyapatite, magnesium chloride and magnesium sulfate.

Specifically, the heavy metal capturing agent includes one or more of xanthate, dithiocarbamate derivatives (DTC), trisodium trithiotriazine (TMT), sodium trithiocarbonate (STC) and other new organic sulfur-based heavy metal capturing agents.

Specifically, the second pH adjuster is hydrochloric acid or sulfuric acid.

Specifically, the ammonium salt product is one of ammonium chloride or ammonium sulfate. If the ammonium salt product is ammonium chloride, the agents used in the above steps should be free of sulfates. If the ammonium salt product is ammonium sulfate, the agents used in the above steps should be free of chlorides.

Specifically, the ammonium salt product can be packaged and sold directly or packaged and sold after being dried.

In the described resourceful treatment method of BOE waste liquid, a sodium salt solution is added to the BOE waste liquid to fully precipitate the fluosilicates in the waste liquid to obtain a sodium fluosilicate product, and the excess sodium can be further utilized in the subsequent preparation of a cryolite product. An aluminum salt solution is added in proportion to the filtrate after removal of fluosilicates, and the pH is adjusted to 4-7 and after sufficient reaction, 80-90% of the fluoride ions in the filtrate can be recovered in the form of a cryolite product. A fluorine removal agent and a heavy metal capturing agent are added to the remaining wastewater so that the content of fluoride ions is stably reduced to 3 mg/L or below, and the content of heavy metals (in terms of Pb) is reduced to below the detection limit, thereby significantly reducing the corrosion of fluoride ions to the subsequently used evaporator and obtaining an ammonium salt product with a low heavy metal content by evaporative crystallization. After a series of reactions and impurity removal in the above steps, the main component of the evaporated liquid is ammonium salt with high purity. In order to reduce the ammonia nitrogen content in the evaporated condensate water and avoid impact on the biochemical system, the pH of the evaporated liquid needs to be adjusted to 2-4 by adding acid. Then, a high-purity ammonium salt product can be obtained through evaporation concentration, cooling crystallization and centrifugal separation.

The present invention can determine whether to produce an ammonium chloride product or an ammonium sulfate product according to the content of impurities such as sulfates or chlorides in BOE waste liquid. The present invention can make good resource utilization of the main components in BOE waste liquid, produce sodium fluosilicate, cryolite and agricultural ammonium salt products that meet the requirements of relevant national standards, and realize high-value utilization of resources. In addition, all reactions in the present invention are carried out at the pH of 7 or less, and there is basically no unorganized emission of ammonia during the treatment process, thereby being friendly to the environment and the physical and mental health of operators.

The following are specific examples:

It should be noted that in the following examples, various indicators of sodium fluosilicate products were determined according to the methods specified in “GB/T23936-2018 Sodium Hexafluorosilicate for Industrial Use”, various indicators of cryolite products were determined according to the methods specified in “GB/T4291-2017 Synthetic Cryolite”, and various indicators of ammonium salt products (ammonium sulfate or ammonium chloride) were determined according to the methods specified in “GB/T535-2020 Fertilizer Grade Ammonium Sulfate” and “GB/T2946-2018 Ammonium Chloride”.

### Example 1

The BOE waste liquid in this example mainly comprises 3.58 wt % of ammonium fluosilicate, 18.36 wt % of ammonium fluoride, 0.48 wt % of hydrofluoric acid, 46300 mg/L sulfates, 529 mg/L chlorides, 70 mg/L heavy metals (in terms of Pb), with a density of 1.18 g/cm⁻³. The specific treatment method is as follows:
(1) 570 g of sodium sulfate decahydrate was weighed and dissolved in 1400 g of water, and the resulting solution was added to 1 L of BOE waste liquid at a feed rate of 50 mg/L, followed by reaction for 30 min; the reaction solution was then filtered to obtain sodium fluosilicate and a first waste liquid;
(2) 340 g of aluminum sulfate octadecahydrate was weighed and dissolved in 800 g of water, and the resulting solution was added to the first waste liquid at a feed rate of 40 mg/L; solid sodium hydroxide was then added to adjust the pH value of the waste liquid to 6.5, followed by reaction for 2 h; the reaction solution was then filtered to obtain cryolite and a second waste liquid;
(3) the fluorine content and heavy metal content (in terms of Pb) of the second waste liquid were determined to be 322 mg/L and 45 mg/L, respectively; 9 g of fluorine removal agent and 2.7 g of heavy metal capturing agent were added, followed by reaction for 30 min; the reaction solution was then filtered to obtain a first waste residue and a third waste liquid;
(4) sulfuric acid was added to the third waste liquid to adjust the pH of the third waste liquid to 4, and the third waste liquid was evaporated and crystallized to obtain evaporated condensate water and a concentrated solution;
(5) the concentrated liquid was cooled to room temperature and filtered to obtain ammonium sulfate and a final mother solution; and
(6) the third waste liquid and the final mother solution were returned to the front end for the preparation of the sodium sulfate solution and the aluminum sulfate solution.

In this example, the dried sodium fluosilicate product had a purity of 99.2%, a free acid content (in terms of HCl) of 0.05%, a drying loss of 0.08%, a chloride content of 0.02%, a water-insoluble content of 0.11%, a sulfate content of 0.24%, iron and phosphorus pentoxide contents being below the detection limits, and a heavy metal content (in terms of Pb) of 0.0001%, and the content of each indicator meets the requirements of Type I superior products specified in “GB/T23936-2018 Sodium Hexafluorosilicate for Industrial Use”. After being washed and dried, the cryolite product had a fluorine content of 52.3%, an aluminum content of 12.2%, a sodium content of 33.6%, a silicon dioxide content of 0.15%, iron oxide, calcium oxide, and phosphorus pentoxide contents being below the detection limits, a sulfate content of 0.52%, a moisture retention of 0.12%, and a loss on burn of 1.3%, and the content of each indicator meets the requirements of the CH-1 grade specified in “GB/T4291-2017 Synthetic Cryolite”. The dried ammonium sulfate product had a nitrogen content of 20.8%, a sulfur content of 24.5%, a free acid (H₂SO₄) content of 0.001%, a moisture content of 0.13%, a water-insoluble content of 0.22%, a chloride ion content of 0.05%, a fluorine content of 12 mg/kg, and a total amount of thiocyanate ions and polycyclic aromatic hydrocarbons being below the detection limit, a mercury content of 0.02 mg/kg, an arsenic content of 0.05 mg/kg, a cadmium content of 0.11 mg/kg, a lead content of 1.5 mg/kg, and a chromium content of 2.6 mg/kg, and the content of each indicator meets the index requirements of Type I products specified in “GB/T535-2020 Fertilizer Grade Ammonium Sulfate”. In addition, the fluorine content in the third waste liquid was 1.5 mg/L, which greatly reduces the corrosion of fluorine ions to the subsequently used evaporator.

### Example 2

The BOE waste liquid in this example mainly comprises 3.58 wt % of ammonium fluosilicate, 18.36 wt % of ammonium fluoride, 0.48 wt % of hydrofluoric acid, 46300 mg/L sulfates, 529 mg/L chlorides, 70 mg/L heavy metals (in terms of Pb), with a density of 1.18 g/cm⁻³. The specific treatment method is as follows:
(1) 627 g of sodium sulfate decahydrate was weighed and dissolved in 1500 g of water, and the resulting solution was added to 1 L of BOE waste liquid at a feed rate of 50 mg/L, followed by reaction for 30 min; the reaction solution was then filtered to obtain sodium fluosilicate and a first waste liquid;
(2) 375 g of aluminum sulfate octadecahydrate was weighed and dissolved in 1000 g of water, and the resulting solution was added to the first waste liquid at a feed rate of 40 mg/L; solid sodium hydroxide was then added to adjust the pH value of the waste liquid to 4.5, followed by reaction for 2 h; the reaction solution was then filtered to obtain cryolite and a second waste liquid;
(3) the fluorine content and heavy metal content (in terms of Pb) of the second waste liquid were determined to be 1189 mg/L and 66 mg/L, respectively; 20.8 g of fluorine removal agent and 3.5 g of heavy metal capturing agent were added, followed by reaction for 30 min; the reaction solution was then filtered to obtain a first waste residue and a third waste liquid;
(4) sulfuric acid was added to the third waste liquid to adjust the pH of the third waste liquid to 3, and the third waste liquid was evaporated and crystallized to obtain evaporated condensate water and a concentrated solution;
(5) the concentrated liquid was cooled to room temperature and filtered to obtain ammonium sulfate and a final mother solution; and
(6) the third waste liquid and the final mother solution were returned to the front end for the preparation of the sodium sulfate solution and the aluminum sulfate solution.

In this example, the dried sodium fluosilicate product had a purity of 98.7%, a free acid content (in terms of HCl) of 0.08%, a drying loss of 0.1%, a chloride content of 0.02%, a water-insoluble content of 0.18%, a sulfate content of 0.27%, iron and phosphorus pentoxide contents being below the detection limits, and a heavy metal content (in terms of Pb) of 0.0002%, and the content of each indicator meets the requirements of Type I first-class products specified in “GB/T23936-2018 Sodium Hexafluorosilicate for Industrial Use”. After being washed and dried, the cryolite product had a fluorine content of 53.2%, an aluminum content of 13.1%, a sodium content of 32.3%, a silicon dioxide content of 0.18%, iron oxide, calcium oxide, and phosphorus pentoxide contents being below the detection limits, a sulfate content of 0.38%, a moisture retention of 0.13%, and a loss on burn of 1.6%, and the content of each indicator meets the requirements of the CM-0 grade specified in “GB/T4291-2017 Synthetic Cryolite”. The dried ammonium sulfate product had a nitrogen content of 20.6%, a sulfur content of 25.2%, a free acid (H₂SO₄) content of 0.01%, a moisture content of 0.12%, a water-insoluble content of 0.18%, a chloride ion content of 0.04%, a fluorine content of 23 mg/kg, and a total amount of thiocyanate ions and polycyclic aromatic hydrocarbons being below the detection limit, a mercury content of 0.02 mg/kg, an arsenic content of 0.04 mg/kg, a cadmium content of 0.13 mg/kg, a lead content of 0.8 mg/kg, and a chromium content of 1.9 mg/kg, and the content of each indicator meets the index requirements of Type I products specified in “GB/T535-2020 Fertilizer Grade Ammonium Sulfate”. In addition, the fluorine content in the third waste liquid was 2.3 mg/L, which greatly reduces the corrosion of fluorine ions to the subsequently used evaporator.

### Example 3

The BOE waste liquid in this example mainly comprises 9.66 wt % of ammonium fluosilicate, 10.28 wt % of ammonium fluoride, 0.52 wt % of hydrofluoric acid, 368 mg/L sulfates, 17400 mg/L chlorides, 95 mg/L heavy metals (in terms of Pb), with a density of 1.15 g/cm⁻³. The specific treatment method is as follows:
(1) 210 g of NaCl was weighed and dissolved in 600 g of water, and the resulting solution was added to 1 L of BOE waste liquid at a feed rate of 30 mg/L, followed by reaction for 30 min; the reaction solution was then filtered to obtain sodium fluosilicate and a first waste liquid;
(2) 170 g of aluminum chloride hexahydrate was weighed and dissolved in 400 g of water, and the resulting solution was added to the first waste liquid at a feed rate of 20 mg/L; ammonia water was then added to adjust the pH value of the waste liquid to 7.0, followed by reaction for 2 h; the reaction solution was then filtered to obtain cryolite and a second waste liquid;
(3) the fluorine content and heavy metal content (in terms of Pb) of the second waste liquid were determined to be 155 mg/L and 38 mg/L, respectively; 1.0 g of fluorine removal agent and 0.8 g of heavy metal capturing agent were added, followed by reaction for 30 min; the reaction solution was then filtered to obtain a first waste residue and a third waste liquid;
(4) hydrochloric acid was added to the third waste liquid to adjust the pH of the third waste liquid to 2, and the third waste liquid was evaporated and crystallized to obtain evaporated condensate water and a concentrated solution;
(5) the concentrated liquid was cooled to room temperature and filtered to obtain ammonium chloride and a final mother solution; and
(6) the third waste liquid and the final mother solution were returned to the front end for the preparation of the NaCl solution and the aluminum chloride solution.

In this example, the dried sodium fluosilicate product had a purity of 98.6%, a free acid content (in terms of HCl) of 0.08%, a drying loss of 0.23%, a chloride content of 0.18%, a water-insoluble content of 0.25%, a sulfate content of 0.01%, iron and phosphorus pentoxide contents being below the detection limits, and a heavy metal content (in terms of Pb) of 0.0002%, and the content of each indicator meets the requirements of Type I first-class products specified in “GB/T23936-2018 Sodium Hexafluorosilicate for Industrial Use”. After being washed and dried, the cryolite product had a fluorine content of 53.1%, an aluminum content of 13.5%, a sodium content of 32.7%, a silicon dioxide content of 0.13%, iron oxide, calcium oxide, and phosphorus pentoxide contents being below the detection limits, a sulfate content of 0.01%, a moisture retention of 0.11%, and a loss on burn of 2.2%, and the content of each indicator meets the requirements of the CM-1 grade specified in “GB/T4291-2017 Synthetic Cryolite”. The ammonium chloride product had a nitrogen content of 23.7%, a moisture content of 8.2%, a sodium content of 1.4%, an arsenic content of 0.000002%, a cadmium content of 0.000015%, a lead content of 0.00013%, a chromium content of 0.00016%, and a mercury content of 0.000001%, and the content of each indicator meets the index requirements of qualified products specified in “GB/T2946-2018 Ammonium Chloride”. In addition, the fluorine content in the third waste liquid was 0.56 mg/L, which greatly reduces the corrosion of fluorine ions to the subsequently used evaporator.

### Example 4

The BOE waste liquid in this example mainly comprises 9.66 wt % of ammonium fluosilicate, 10.28 wt % of ammonium fluoride, 0.52 wt % of hydrofluoric acid, 368 mg/L sulfates, 17400 mg/L chlorides, 95 mg/L heavy metals (in terms of Pb), with a density of 1.15 g/cm⁻³. The specific treatment method is as follows:
(1) 192 g of NaCl was weighed and dissolved in 600 g of water, and the resulting solution was added to 1 L of BOE waste liquid at a feed rate of 30 mg/L, followed by reaction for 30 min; the reaction solution was then filtered to obtain sodium fluosilicate and a first waste liquid;
(2) 155 g of aluminum chloride hexahydrate was weighed and dissolved in 400 g of water, and the resulting solution was added to the first waste liquid at a feed rate of 20 mg/L; solid sodium carbonate was then added to adjust the pH value of the waste liquid to 4.0, followed by reaction for 2 h; the reaction solution was then filtered to obtain cryolite and a second waste liquid;
(3) the fluorine content and heavy metal content (in terms of Pb) of the second waste liquid were determined to be 2350 mg/L and 86 mg/L, respectively; 45 g of fluorine removal agent and 3.0 g of heavy metal capturing agent were added, followed by reaction for 30 min; the reaction solution was then filtered to obtain a first waste residue and a third waste liquid;
(4) hydrochloric acid was added to the third waste liquid to adjust the pH of the third waste liquid to 3.5, and the third waste liquid was evaporated and crystallized to obtain evaporated condensate water and a concentrated solution;
(5) the concentrated liquid was cooled to room temperature and filtered to obtain ammonium chloride and a final mother solution; and
(6) the third waste liquid and the final mother solution were returned to the front end for the preparation of the NaCl solution and the aluminum chloride solution.

In this example, the dried sodium fluosilicate product had a purity of 98.8%, a free acid content (in terms of HCl) of 0.06%, a drying loss of 0.19%, a chloride content of 0.16%, a water-insoluble content of 0.21%, a sulfate content of 0.01%, iron and phosphorus pentoxide contents being below the detection limits, and a heavy metal content (in terms of Pb) of 0.0003%, and the content of each indicator meets the requirements of Type I first-class products specified in “GB/T23936-2018 Sodium Hexafluorosilicate for Industrial Use”. After being washed and dried, the cryolite product had a fluorine content of 52.2%, an aluminum content of 12.3%, a sodium content of 33.3%, a silicon dioxide content of 0.16%, iron oxide, calcium oxide, and phosphorus pentoxide contents being below the detection limits, a sulfate content of 0.013%, a moisture retention of 0.12%, and a loss on burn of 1.1%, and the content of each indicator meets the requirements of the CH- 0 grade specified in “GB/T 4291-2017 Synthetic Cryolite”. The ammonium chloride product had a nitrogen content of 23.8%, a moisture content of 7.8%, a sodium content of 1.2%, an arsenic content of 0.000003%, a cadmium content of 0.00002%, a lead content of 0.00018%, a chromium content of 0.00019%, and a mercury content of 0.000002%, and the content of each indicator meets the index requirements of qualified products specified in “GB/T2946-2018 Ammonium Chloride”. In addition, the fluorine content in the third waste liquid was 1.22 mg/L, which greatly reduces the corrosion of fluorine ions to the subsequently used evaporator.

The above embodiments only describe several implementations of the invention, and their description is specific and detailed, but cannot therefore be construed as limiting the scope of the invention. It should be noted that those of ordinary skill in the art may further make variations and improvements without departing from the concept of the invention, and these all should fall within the scope of the invention. Therefore, the scope of the present disclosure shall be based on the appended claims.

1. A resourceful treatment method of BOE waste liquid, characterized by, comprising the following steps:
S1, dissolving a sodium salt to obtain a sodium salt solution, adding the sodium salt solution to a BOE waste liquid for reaction for 30 min, and then filtering the reaction solution to obtain sodium fluosilicate and a first waste liquid;
S2, dissolving an aluminum salt to obtain an aluminum salt solution, adding the aluminum salt solution to the first waste liquid, adjusting the pH of the first waste liquid to 4-7 by using a first pH adjuster, reacting same for 1-2 h and then filtering the reaction solution to obtain cryolite and a second waste liquid;
S3, adding a fluorine removal agent and a heavy metal capturing agent to the second waste liquid for reaction for 30 min, and then filtering the reaction solution to obtain a first waste residue and a third waste liquid, and landfilling the first waste residue;
S4, adding a second pH adjuster to the third waste liquid to adjust the pH of the third waste liquid to 2-4, subjecting the third waste liquid to evaporative crystallization to obtain evaporated condensate water and a concentrated solution, subjecting the evaporated condensate water to a biochemical treatment, and discharging the evaporated condensate water after same reaches the discharge standard;
S5, pumping the concentrated solution into a cooling crystallization tank for cooling for 40° C., and subjecting same to centrifugal separation to obtain an ammonium salt and a final mother solution; and
S6, returning the third waste liquid and the final mother solution to S1 and S2 for circulation so as to prepare the sodium salt solution and the aluminum salt solution.

2. The resourceful treatment method of BOE waste liquid according to claim 1, characterized in that, the sodium salt comprises one or more of sodium chloride, sodium sulfate, sodium carbonate and sodium bicarbonate, and the amount of the sodium salt added (in terms of sodium) is calculated based on the sodium required to completely remove fluosilicates and fluorides out of the BOE waste liquid and precipitate sodium fluosilicate and sodium hexafluoroaluminate, and an excess coefficient is 1-1.2 times.

3. The resourceful treatment method of BOE waste liquid according to claim 1, characterized in that, the aluminum salt comprises one or more of aluminum chloride, aluminum sulfate and sodium aluminate, and the amount of the aluminum salt added (in terms of aluminum) is calculated based on the aluminum required to completely remove fluorides out of the first waste liquid and precipitate sodium hexafluoroaluminate, and an excess coefficient is 1-1.2 times.

4. The resourceful treatment method of BOE waste liquid according to claim 1, characterized in that, the first pH adjuster comprises one or more of sodium hydroxide, sodium carbonate, sodium bicarbonate, ammonia water, ammonium bicarbonate and ammonium carbonate.

5. The resourceful treatment method of BOE waste liquid according to claim 1, characterized in that, step S1 and step S2 also respectively comprise washing and drying the sodium fluosilicate and the cryolite, respectively.

6. The resourceful treatment method of BOE waste liquid according to claim 1, characterized in that, the fluorine removal agent comprises one or more of aluminum chloride, polyaluminum chloride, aluminum sulfate, hydroxyapatite, magnesium chloride and magnesium sulfate.

7. The resourceful treatment method of BOE waste liquid according to claim 1, characterized in that, the second pH adjuster is hydrochloric acid or sulfuric acid.
